(19) United States
(12) Patent Application Publication
(10) Pub. No.: US 2024/0357465 A1
(43) Pub. Date: Oct. 24, 2024

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/761,857

(22) Filed: Jul. 2, 2024

Related U.S. Application Data
(63) Continuation of application No. PCT/JP2022/047870, filed on Dec. 26, 2022.
(60) Provisional application No. 63/296,226, filed on Jan. 4, 2022.

(51) Int. Cl. H04W 40/12; H04L 1/24; H04W 28/04

(52) U.S. Cl. CPC H04W 40/12; H04L 1/24; H04W 28/04

(57) ABSTRACT

In a first aspect, a communication control method is used in a cellular communication system. The communication control method includes, by a relay node, including additional information in a failure occurrence notification indicating occurrence of a failure in a first backhaul link between a first parent node and the relay node, and transmitting the additional information to a child node. The communication control method includes receiving, by the child node, the failure occurrence notification including the additional information. Here, the additional information includes a first BAP routing ID unavailable due to the failure and/or a first destination BAP address included in the first BAP routing ID, and includes identification information indicating that the additional information includes the BAP routing ID and/or the first destination BAP address.

### RELATED APPLICATIONS

The present application is a continuation based on PCT Application No. PCT/JP2022/047870, filed on Dec. 26, 2022, which claims the benefit of U.S. Provisional Patent Application No. 63/296,226 filed on Jan. 4, 2022. The content of which is incorporated by reference herein in their entirety.

### TECHNICAL FIELD

The present disclosure relates to a communication control method used in a cellular communication system.

### BACKGROUND OF INVENTION

In the Third Generation Partnership Project (3GPP), which is a project for the standardization of cellular communication systems, introducing a new relay node referred to as an Integrated Access and Backhaul (IAB) node (for example, see “3GPP TS 38.300 V16.7.0 (2021-09)”) is being considered. One or more relay nodes are involved in communication between a base station and a user equipment and perform relay for the communication.

### SUMMARY

In a first aspect, a communication control method is executed in a relay node having dual connectivity with a first parent node and a second parent node. The communication control method includes detecting a radio link failure in one of a first backhaul link between a first parent node and a relay node or a second backhaul link between a second parent node and the relay node. The communication control method includes transmitting a failure detection notification to a child node when determining that local rerouting cannot be executed.

In a second aspect, a relay node has dual connectivity with a first parent node and a second parent node. The relay node includes a controller configured to detect a radio link failure in one of a first backhaul link between a first parent node and a relay node or a second backhaul link between a second parent node and the relay node. The relay node includes a transmitter configured to transmit a failure detection notification to a child node when determining that local rerouting cannot be executed.

In a third aspect, a processor controls a relay node having dual connectivity with a first parent node and a second parent node. The processor executes processing of detecting a radio link failure in one of a first backhaul link between a first parent node and a relay node or a second backhaul link between a second parent node and the relay node. The processor executes processing of transmitting a failure detection notification to a child node when determining that local rerouting cannot be executed.

In a fourth aspect, a communication control method is used in a cellular communication system. The communication control method includes, by a relay node, including additional information in a failure occurrence notification indicating occurrence of a failure in a first backhaul link between a first parent node and the relay node, and transmitting the additional information to a child node. The communication control method includes receiving, by the child node, the failure occurrence notification including the additional information. Here, the additional information includes a first BAP routing ID unavailable due to the failure and/or a first destination BAP address included in the first BAP routing ID, and includes identification information indicating that the additional information includes the BAP routing ID and/or the first destination BAP address.

In a fifth aspect, a communication control method is used in a cellular communication system. The communication control method includes receiving, by a relay node, a failure occurrence notification indicating occurrence of a failure from a parent node. The communication control method includes performing, by the relay node, a predetermined action in response to reception of the failure occurrence notification. The communication control method further includes canceling, by the relay node, the predetermined action when predetermined processing is performed. Here, the predetermined processing includes a change of a routing configuration.

In a sixth aspect, a communication control method is used in a cellular communication system. The communication control method includes receiving, by a relay node, a failure occurrence notification indicating occurrence of a failure from a parent node. The communication control method includes identifying, by the relay node, a logical channel ID corresponding to an unavailable routing ID included in the failure occurrence notification. The communication control method further includes performing, by the relay node, exclusion processing of excluding data available for transmission corresponding to the logical channel ID from a target of a BSR. The communication control method further includes transmitting, by the relay node, the BSR to the parent node.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to an embodiment.

FIG. 4 is a diagram illustrating a configuration example of an IAB node (relay node) according to an embodiment.

FIG. 5 is a diagram illustrating a configuration example of a UE (user equipment) according to an embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIG. 9 is a diagram illustrating an inter-node configuration example according to a first embodiment.

FIG. 10 is a diagram illustrating an inter-node configuration example according to the first embodiment.

FIG. 11 is a diagram illustrating a first operation example according to the first embodiment.

FIGS. 12A and 12B are diagrams illustrating route examples according to the first embodiment.

FIGS. 13A and 13B are diagrams illustrating route examples according to the first embodiment.

FIG. 14 is a diagram illustrating a route example according to the first embodiment.

FIG. 15A is a diagram illustrating a configuration example of a header part according to the first embodiment, and FIG. 15B is a diagram illustrating an example of PDU Type according to the first embodiment.

FIG. 16 is a diagram illustrating a configuration example of a Type-2 Indication BAP Control PDU according to the first embodiment.

FIG. 17 is a diagram illustrating a second operation example according to the first embodiment.

FIGS. 18A and 18B are diagrams illustrating inter-node configuration examples according to a second embodiment.

FIG. 19 is a diagram illustrating a first operation example according to the second embodiment.

FIG. 20 is a diagram illustrating a second operation example according to the second embodiment.

FIG. 21 is a diagram illustrating an inter-node configuration example according to a third embodiment.

FIG. 22 is a diagram illustrating an operation example according to the third embodiment.

FIG. 23 is a diagram illustrating a pair of operations of the child node for without local rerouting and with partial local rerouting.

### DESCRIPTION OF EMBODIMENTS

A cellular communication system in an embodiment is described with reference to the drawings. In the description of the drawings, the same or similar parts are denoted by the same or similar reference signs.

### Configuration of Cellular Communication System

A configuration example of the cellular communication system according to an embodiment is described. In an embodiment, a cellular communication system 1 is a 3GPP 5G system. Specifically, a radio access scheme in the cellular communication system 1 is New Radio (NR) being a 5G radio access scheme. Note that Long Term Evolution (LTE) may be at least partially applied to the cellular communication system 1. A future cellular communication system such as 6G may be applied to the cellular communication system 1.

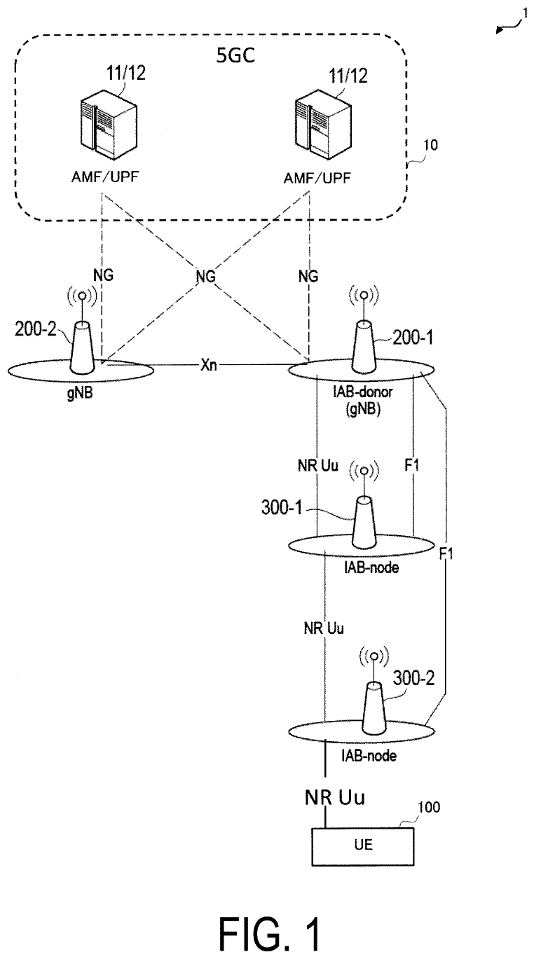

FIG. 1 is a diagram illustrating a configuration example of the cellular communication system 1 according to an embodiment.

As illustrated in FIG. 1, the cellular communication system 1 includes a 5G core network (5GC) 10, a User Equipment (UE) 100, base station apparatuses (hereinafter, also referred to as base stations in some cases) 200-1 and 200-2, and IAB nodes 300-1 and 300-2. The base station 200 may be referred to as a gNB.

An example in which the base station 200 is an NR base station is mainly described below, but the base station 200 may also be an LTE base station (i.e., an eNB).

Note that hereinafter, the base stations 200-1 and 200-2 may be referred to as a gNB 200 (or the base station 200 in some cases), and the IAB nodes 300-1 and 300-2 may be referred to as an IAB node 300.

The 5GC 10 includes an Access and Mobility Management Function (AMF) 11 and a User Plane Function (UPF) 12. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. One cell belongs to one carrier frequency. Hereinafter, the cell and the base station may be used without distinction.

Each gNB 200 is interconnected to the 5GC 10 via an interface referred to as an NG interface. FIG. 1 illustrates a gNB 200-1 and a gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of the NR access. The donor gNB 200-1 (or a donor node, which hereinafter may be also referred to as a “donor node”) is a donor base station that is a terminal node of the NR backhaul on the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul hops.

The UE 100 is a mobile wireless communication apparatus that performs wireless communication with the cells. The UE 100 may be any type of apparatus as long as the UE 100 is an apparatus that performs wireless communication with the gNB 200 or the IAB node 300. For example, the UE 100 includes a mobile phone terminal, a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

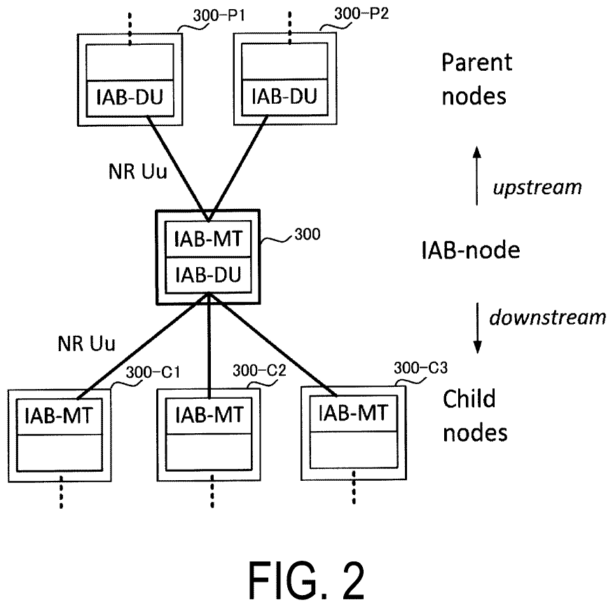

FIG. 2 is a diagram illustrating an example of a relationship between the IAB node 300, parent nodes, and child nodes.

As illustrated in FIG. 2, each IAB node 300 includes an IAB-DU corresponding to a base station functional unit and an IAB-Mobile Termination (IAB-MT) corresponding to a user equipment functional unit.

Neighboring nodes of the IAB-MT (i.e., upper node) of an NR Uu wireless interface are referred to as “parent nodes”. The parent node is the DU of a parent IAB node or the donor node 200. A radio link between the IAB-MT and each parent node is referred to as a backhaul link (BH link). FIG. 2 illustrates an example in which the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes of the IAB-DU (i.e., lower nodes) of an NR access interface are referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the FI protocol for the CU of the donor node 200-1. FIG. 2 illustrates an example in which the child nodes of the IAB node 300 are IAB nodes 300-C1 to 300-C3; however, the UE 100 may be included in the child nodes of the IAB node 300. Note that the direction toward the child nodes is referred to as downstream.

All of the IAB nodes 300 connected to the donor node 200 via one or more hops form a Directed Acyclic Graph (DAG) topology (which may be referred to as “topology” below) rooted at the donor node 200. In this topology, the neighboring nodes of the IAB-DU in the interface are child nodes, and the neighboring nodes of the IAB-MT in the interface are parent nodes as illustrated in FIG. 2. The donor node 200 performs, for example, centralized management on resources, topology, and routes of the IAB topology. The donor node 200 is a gNB that provides network access to the UE 100 via a network of backhaul links and access links.

### Configuration of Base Station

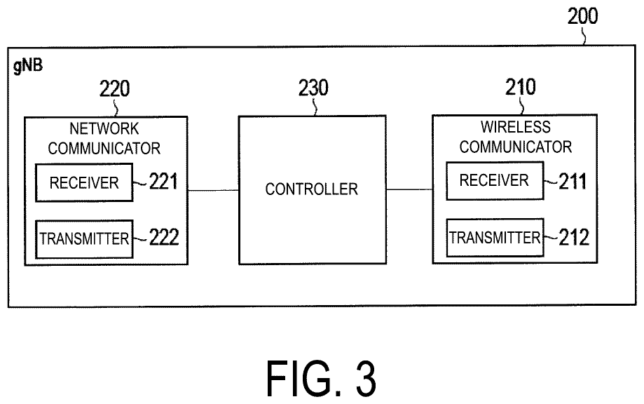

A configuration of the gNB 200 that is a base station according to the embodiment is described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) which is then transmitted to the controller 230. The transmitter 212 performs various types of transmission under control of the controller 230. The transmitter 212 includes an antenna and converts (up-converts) the baseband signal (transmission signal) output by the controller 230 into a radio signal which is then transmitted from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the reception signal to the controller 230. The transmitter 222 performs various types of transmission under control of the controller 230. The transmitter 222 transmits the transmission signal output by the controller 230 to an external destination.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 230 may perform all of the processing and operations in the gNB 200 in each embodiment to be described below.

### Configuration of Relay Node

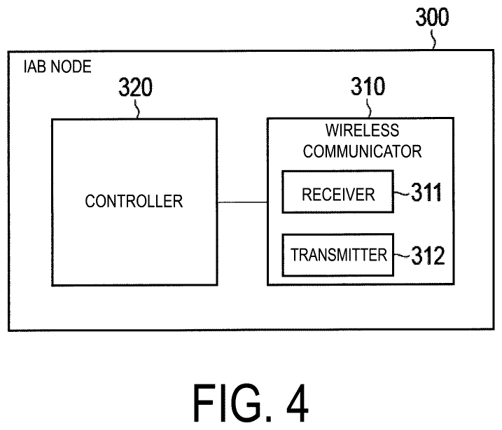

A configuration of the IAB node 300 that is a relay node (or a relay node apparatus. May hereinafter also be referred to as a “relay node” below) according to the embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link). The wireless communicator 310 for the BH link communication and the wireless communicator 310 for the access link communication may be provided separately.

The wireless communicator 310 includes a receiver 311 and a transmitter 312. The receiver 311 performs various types of reception under control of the controller 320. The receiver 311 includes an antenna and converts (down-converts) a radio signal received by the antenna into a baseband signal (reception signal) which is then transmitted to the controller 320. The transmitter 312 performs various types of transmission under control of the controller 320. The transmitter 312 includes an antenna and converts (up-converts) the baseband signal (transmission signal) output by the controller 320 into a radio signal which is then transmitted from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 320 may perform all of the processing and operations in the IAB node 300 in each embodiment to be described below.

### Configuration of User Equipment

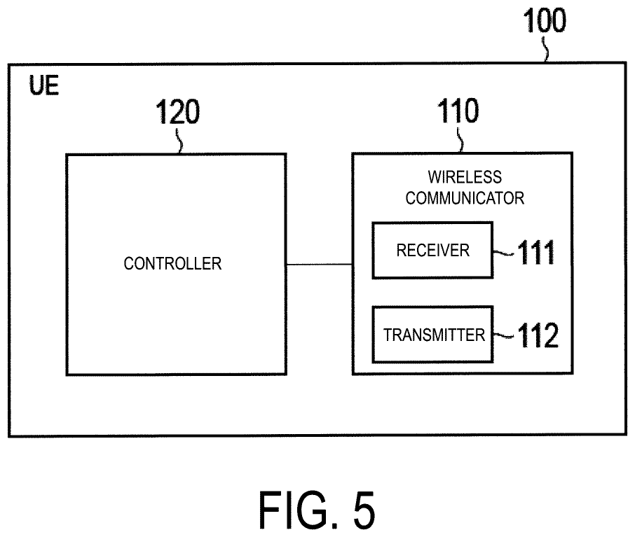

A configuration of the UE 100 that is a user equipment according to the embodiment is described next. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) which is then transmitted to the controller 120. The transmitter 112 performs various types of transmission under control of the controller 120. The transmitter 112 includes an antenna and converts (up-converts) the baseband signal (transmission signal) output by the controller 120 into a radio signal which is then transmitted from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. Note that the controller 120 may perform all of the processing in the UE 100 in each embodiment described below.

### Configuration of Protocol Stack

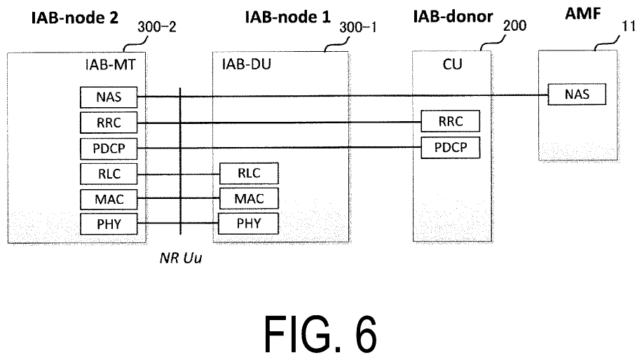

A configuration of a protocol stack according to the embodiment is described next. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines uplink and the downlink transport formats (transport block sizes, Modulation and Coding Schemes (MCSs)) and resource blocks.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection to the donor node 200 is present, the IAB-MT is in an RRC connected state. When no RRC connection to the donor node 200 is present, the IAB-MT is in an RRC idle state.

The NAS layer which is positioned upper than the RRC layer performs session management, mobility management, and the like. NAS signaling is transmitted between the NAS layer of the IAB-MT of the IAB node 300-2 and the AMF 11.

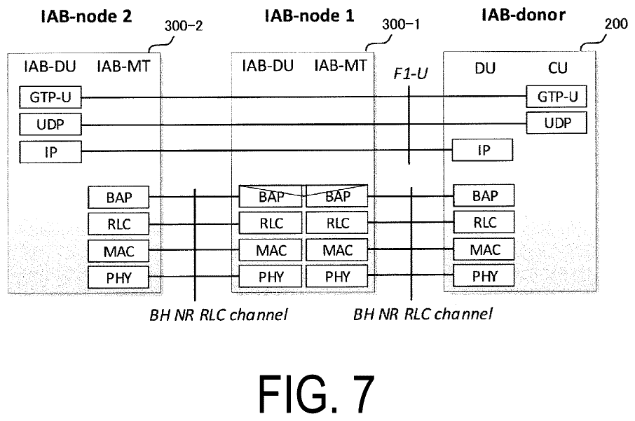

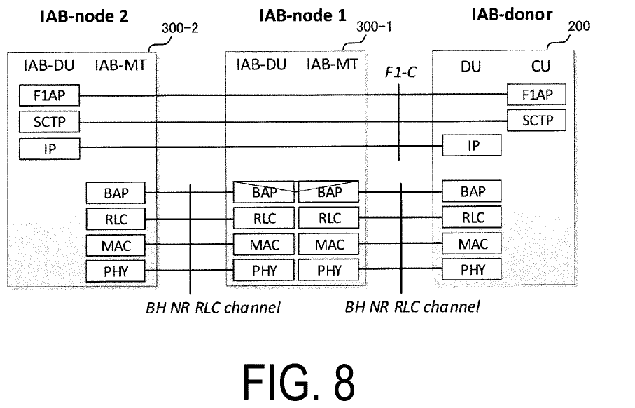

FIG. 7 is a diagram illustrating a protocol stack related to an F1-U protocol. FIG. 8 is a diagram illustrating a protocol stack related to an F1-C protocol. An example is illustrated in which the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as an upper layer of the RLC layer. The BAP layer performs routing processing, and bearer mapping and demapping processing. In the backhaul, the IP layer is transmitted via the BAP layer to allow routing through a plurality of hops.

In each backhaul link, a Protocol Data Unit (PDU) of the BAP layer is transmitted by the backhaul RLC channel (BH NR RLC channel). Configuring a plurality of backhaul RLC channels in each BH link enables the prioritization and Quality of Service (QOS) control of traffic. The association between the BAP PDU and the backhaul RLC channel is executed by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. Furthermore, a downstream direction and a downlink (DL) direction may be used without distinction.

### First Embodiment

A first embodiment will be described.

First, an example of BH RLF Indication according to the first embodiment will be described.

### BH RLF Indication

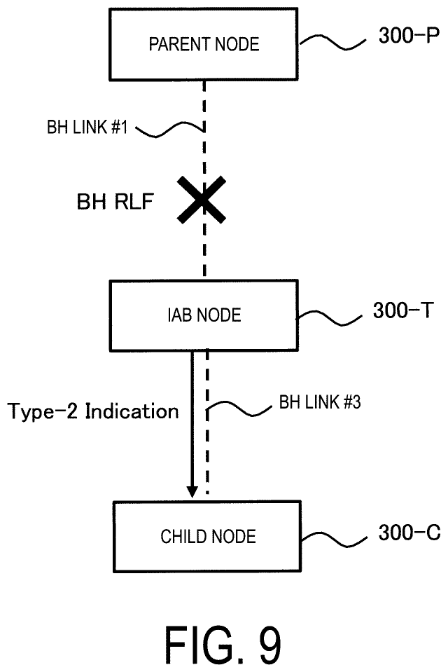

FIG. 9 is a diagram illustrating an inter-node configuration example according to the first embodiment.

The cellular communication system 1 illustrated in FIG. 9 includes an IAB node 300-T, an IAB node 300-P, and an IAB node 300-C.

The IAB node 300-P is a parent node of the IAB node 300-T. Hereinafter, the IAB node 300-P may be also referred to as the parent node 300-P. A backhaul link (BH link) #1 is established between the IAB-DU of the parent node 300-P and the IAB-MT of the IAB node 300-T. Note that the parent node 300-P1 may be (a DU #1 of) the donor node 200.

The IAB node 300-C is a child node of the IAB node 300-T. Hereinafter, the IAB node 300-C may be also referred to as the child node 300-C. A BH link #3 is established between the IAB-MT of the child node 300-C and the IAB-DU of the IAB node 300-T.

In such a configuration, a failure may occur in BH link #1. Such a failure may be referred to as a “BH Radio Link Failure (RLF)”. It is assumed that the IAB-MT of the IAB node 300-T detects the BH RLF.

When the IAB-DU of the IAB node 300-T detects the BH RLF of BH link #1, the IAB-DU can transmit a failure detection notification (or a failure occurrence notification) to the IAB-DU of the child node 300-C. Type-2 Indication is an example of the failure detection notification transmitted when the BH RLF is detected. Type-2 Indication indicates BH RLF detection indication. Type-2 Indication may be referred to as “Type-2” or “type-2 indication”.

On the other hand, when the IAB-MT of the IAB node 300-T detects the RLF of BH link #1, the IAB-MT performs recovery from the RLF in BH link #1. When the IAB-DU of the IAB node 300-T succeeds in recovery from the RLF of BH link #1, the IAB-DU can transmit a recovery success notification to the IAB-DU of the child node 300-C. Type-3 Indication is an example of the recovery success notification. Type-3 Indication indicates BF RLF recovery indication. Type-3 Indication may be referred to as “Type-3” or “type-3 indication”.

Note that the IAB-MT of the IAB node 300-T may fail in recovery from the RLF in BH link #1. When the IAB-DU of the IAB node 300-T fails in recovery from the RLF of BH link #1, the IAB-DU can transmit a recovery failure notification to the IAB-DU of the child node 300-C. Type-4 Indication is an example of the recovery failure notification. Type-4 Indication may be referred to as “Type-4” or “type-4 indication”.

Note that these indications are transmitted being included in a BAP Control Protocol Data Unit (PDU) or a MAC Control Element (CE).

### Communication Control Method According to First Embodiment

In 3GPP, whether to include additional information in Type-2 Indication is a problem to be studied in future.

As the additional information, for example, a case is considered in which a routing ID including a path that has become unavailable due to occurrence of the BH RLF as a path identifier is included in Type-2 Indication.

Here, the routing ID including the route that has become unavailable due to occurrence of the BH RLF as the path identifier may be hereinafter referred to as an unavailable routing ID. Note that the routing ID consists of a destination BAP address (Destination) and a path identifier (Path ID). A BAP routing ID may be referred to as a routing ID.

When the unavailable routing ID is included in Type-2 Indication as the additional information, the child node 300-C that has received the Type-2 Indication can also regard a route other than the unavailable routing ID as a local rerouting target. The child node 300-C can also regard the unavailable routing ID (or a packet having the routing ID in a header) as the local rerouting target, and transfer the packet to a route other than the unavailable routing ID. In other words, regarding an available routing ID, a packet can still be transferred to a route determined in regular routing (not local rerouting). Note that the additional information may be the available routing ID, instead of the unavailable routing ID.

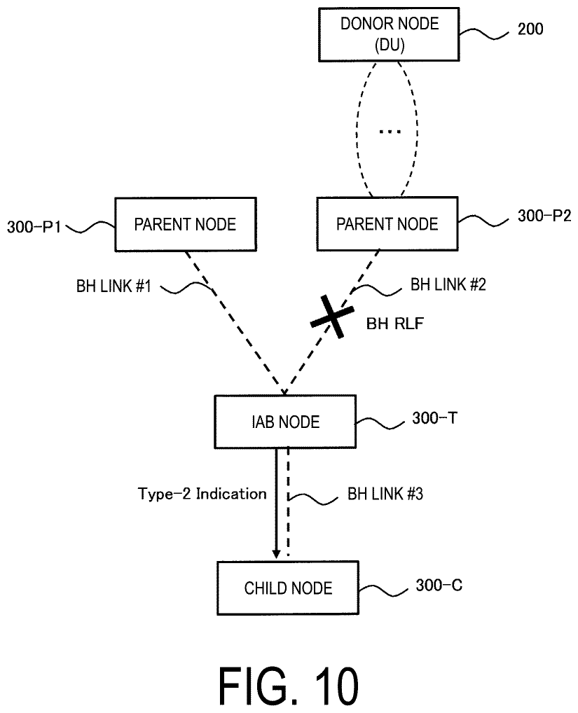

However, when the additional information is included in Type-2 Indication, overhead may increase. In particular, when the IAB node 300-T includes all of the unavailable routing IDs in Type-2 Indication as the additional information, overhead of Type-2 Indication increases. Such a case will be described with reference to FIG. 10 as an example.

FIG. 10 is a diagram illustrating an inter-node configuration example according to the first embodiment. As illustrated in FIG. 10, the IAB node 300-T assumes that Dual Connectivity (DC) is configured for two parent nodes, namely the parent node 300-P1 and the parent node 300-P2. In other words, the parent node 300-P1 functions as a master node (MN) that manages a master cell group (MCG), and the parent node 300-P2 functions as a secondary node (SN) that manages a secondary cell group (SCG). It is assumed that there are a plurality of routes between the parent node 300-P2 and the donor node 200. It is assumed that the BH RLF has occurred in BH link #2 (SCG side) between the IAB node 300-T and the parent node 300-P2.

The SCG side handles the user plane, and thus the IAB node 300-T needs to transmit Type-2 Indication to the child node 300-C.

However, there are a plurality of routes from the IAB node 300-T to the donor node 200 including BH link #2. Thus, there are a plurality of routing IDs that include BH link #2 with the donor node 200 being the destination. The routing IDs are unavailable routing IDs.

Under such a condition, when the IAB node 300-T includes all of the plurality of routing IDs in Type-2 Indication as the additional information, overhead increases.

In view of this, in the first embodiment, the problem is to reduce increase of overhead of Type-2 Indication.

Thus, in the first embodiment, when the destination of the routing ID unavailable due to the BH RLF and the destination of the routing ID available even in the BH RLF are not the same, the destination of the routing ID is included in the additional information, instead of the unavailable routing ID. Details will be described in operation examples.

Thus, instead of the plurality of unavailable routing IDs, the Destination of these routing IDs is included in the additional information as a representative value. Accordingly, increase of overhead of Type-2 Indication can be reduced.

Specifically, firstly, the relay node (for example, the IAB node 300-T) includes the failure occurrence notification indicating occurrence of a failure in a first backhaul link (for example, BH link #2) with a first parent node (for example, the parent node 300-P2) in the additional information, and transmits the additional information to the child node (for example, the child node 300-C). Secondly, the child node receives the failure occurrence notification including the additional information. Here, the additional information includes a first BAP routing ID unavailable due to the failure and/or a first destination BAP address included in the first BAP routing ID, and includes identification information indicating that the additional information includes the BAP routing ID and/or the first destination BAP address.

In this manner, the additional information may include the first destination BAP address, and thus as described above, by using the address (Destination) as the representative value, increase of overhead of Type-2 Indication can be reduced.

Note that, in the first embodiment, a case of Type-3 Indication, instead of Type-2 Indication, can also be implemented. In the following, an example of Type-2 Indication will be described; however, in the following description, the case of Type-3 Indication instead of Type-2 Indication can also be implemented.

### First Operation Example According to First Embodiment

A first operation example according to the first embodiment will be described.

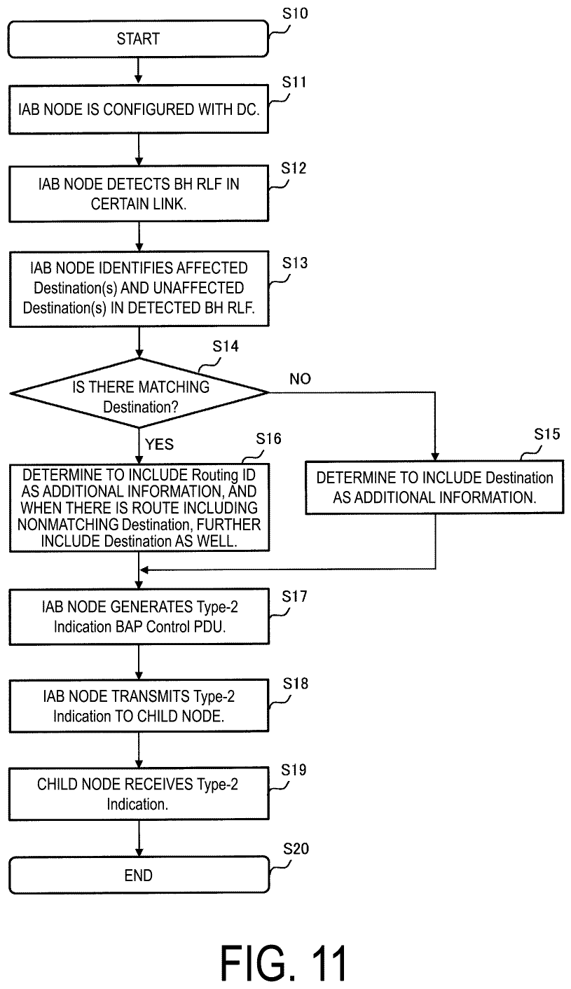

FIG. 11 is a diagram illustrating the first operation example according to the first embodiment. The first operation example according to the first embodiment will be described with appropriate reference to the configuration example illustrated in FIG. 10.

As illustrated in FIG. 11, in Step S10, the IAB node 300-T starts processing.

In Step S11, the IAB node 300-T is configured with DC. For example, as illustrated in FIG. 10, the IAB node 300-T is connected to both of the parent node 300-P1 (for example, a second parent node) and the parent node 300-P2 via DC. Here, the parent node 300-P1 side may be the MCG side, and the parent node 300-P2 side may be the SCG side.

Referring back to FIG. 11, in Step S12, the IAB node 300-T detects a BH RLF in a certain link. For example, as illustrated in FIG. 10, the IAB node 300-T detects an RLF of BH link #2.

Referring back to FIG. 11, in Step S13, the IAB node 300-T identifies the destination of an affected routing ID (to become unavailable) due to the BH RLF and the destination of an unaffected routing ID (still available) due to the BH RLF.

The “affected routing ID” is, for example, a routing ID that has become unavailable due to the BH RLF. The “affected routing ID” may be a routing ID including the route including the BH link with the BH RLF as the path identifier. In the example of FIG. 10, the routing ID including BH link #2 in which the BH RLF has occurred due to the BH RLF as the path identifier may be the “affected routing ID”.

On the other hand, the “unaffected routing ID” is the routing ID available even in the BH RLF. The “unaffected routing ID” may be the routing ID including the route including the BH link (for example, a second backhaul link) in which the failure has not occurred as the path identifier. In the example of FIG. 10, the routing ID including BH link #1 as the path identifier may be the “unaffected routing ID”.

The Destination included in the “affected routing ID” may be referred to as an “affected Destination”. Furthermore, the Destination included in the “unaffected routing ID” may be referred to as an “unaffected Destination”.

Referring back to FIG. 11, in Step S14, the IAB node 300-T compares the affected Destination(s) and the unaffected Destination(s), and determines whether there is a matching Destination(s). In other words, the IAB node 300-T determines whether the destination BAP address (for example, a first destination BAP address) included in the routing ID (for example, a first routing ID) unavailable due to the failure in the BH link and the destination BAP address (for example, a second destination BAP address) included in the routing ID (for example, a second routing ID) available even in the failure in the BH link are the same BAP address.

In Step S14, the affected Destination(s) and the unaffected Destination(s) are compared, and when there is not a matching Destination(s) (NO in Step S14), the processing transitions to Step S15. On the other hand, in Step S14, the affected Destination(s) and the unaffected Destination(s) are compared, and when there is a matching Destination(s) (YES in Step S14), the processing transitions to Step S16.

In Step S15, the IAB node 300-T determines to include the Destination(s) as the additional information. In other words, when the first destination BAP address and the second destination BAP address are not the same BAP address, the IAB node 300-T includes the first destination BAP address and does not include the first routing ID in the additional information.

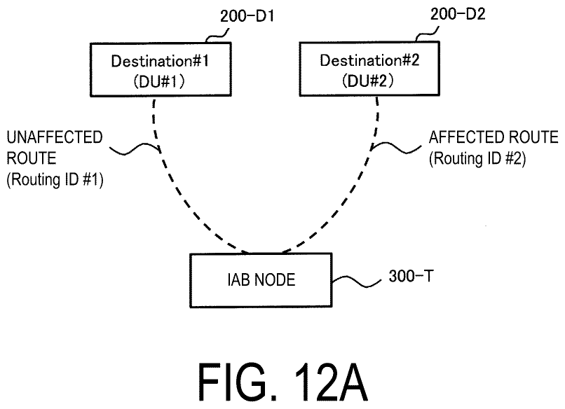

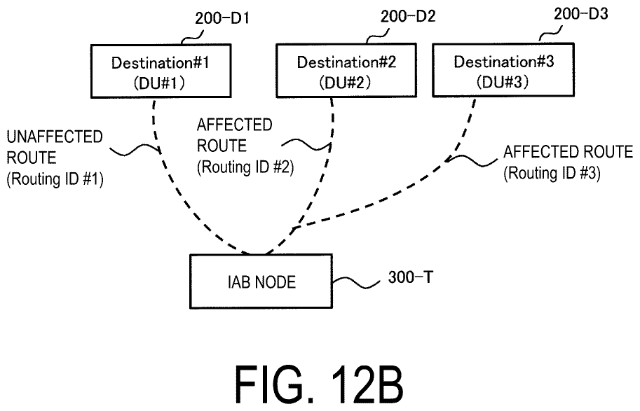

FIG. 12A is a diagram illustrating a route example according to the first embodiment. FIG. 12A illustrates a schematic diagram of routes when the affected Destination and the unaffected Destination do not match. The affected Destination is the BAP address of DU #2 (200-D2) of the donor node 200. The unaffected Destination is the BAP address of DU #1 (200-D1) of the donor node 200.

As illustrated in FIG. 12A, when the affected Destination and the unaffected Destination do not match (or there is not a matching Destination(s)), the IAB node 300-T determines to include the BAP address of DU #2 (200-D2) of the donor node 200 and not include routing ID #2 as the additional information.

Thus, for example, even when there are a plurality of routing IDs from the IAB node 300-T to DU #2 (200-D2) of the donor node 200, by including the Destination in the additional information as the representative value, the plurality of routing IDs need not be included in the additional information. Thus, increase of overhead of the additional information can be reduced. The child node 300-C that has received Type-2 Indication including the Destination as the additional information can determine that all of the routes to the Destination are unavailable (or affected) routes, and can thus execute local rerouting.

FIG. 12B is a diagram illustrating a route example according to the first embodiment. As illustrated in FIG. 12B, when there are a plurality of affected Destinations (the BAP address of DU #2 (200-D2) and the BAP address of DU #3 (200-D3)), and none of them matches the unaffected Destination (DU #1 (200-D1)), there may be a plurality of Destinations included in the additional information. In other words, in the example of FIG. 12B, as the additional information, the destination BAP address of DU #2 (200-D2) and the destination BAP address of DU #3 (300-D3) are included.

Referring back to FIG. 11, in Step S16, firstly, as the additional information, the IAB node 300-T determines to include the routing ID. In other words, when the first destination BAP address and the second destination BAP address are the same BAP address, the IAB node 300-T determines to include the first routing ID in the additional information and not include the first destination BAP address in the additional information.

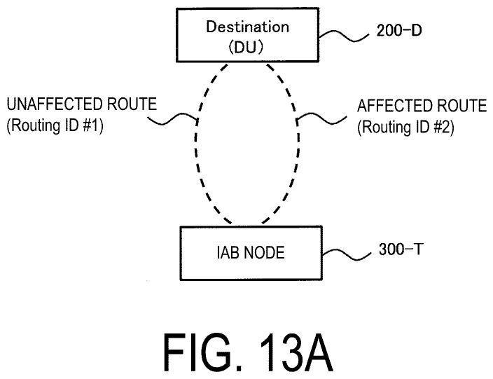

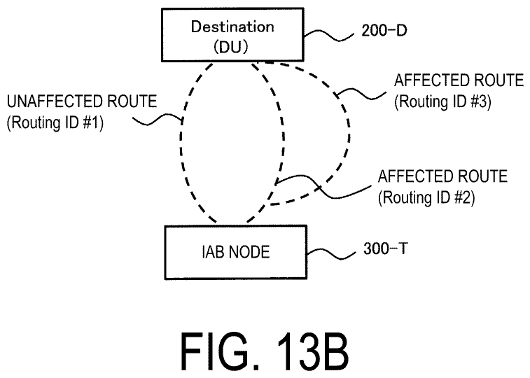

FIG. 13A is a diagram illustrating a route example according to the first embodiment. FIG. 13A is an example in which the destinations of the affected routing ID (routing ID #2) and the unaffected routing ID (routing ID #1) are the same DU (200-D) of the donor node 200. In such a case, as the additional information, by including routing ID #2, the child node 300-C that has received the additional information can execute local rerouting with routing ID #2 being taken into consideration.

FIG. 13B is a diagram illustrating a route example according to the first embodiment. As illustrated in FIG. 13B, when the affected Destination and the unaffected Destination match and there are a plurality of affected routing IDs (routing ID #2 and routing ID #3), the IAB node 300-T may include the affected routing ID in the additional information. In other words, in the example of FIG. 13B, as the additional information, routing ID #2 and routing ID #3 are included.

Referring back to FIG. 11, in Step S16, secondly, when there are routes in which the affected Destination and the unaffected Destination match and the affected Destination and the unaffected Destination do not match, the IAB node 300-T determines to include the routing ID and the Destination. In other words, when a third BAP routing ID available even in the failure is further present, and a third destination BAP address included in the third BAP routing ID and the first destination BAP address are not the same, the additional information includes the first routing ID and the first destination BAP address.

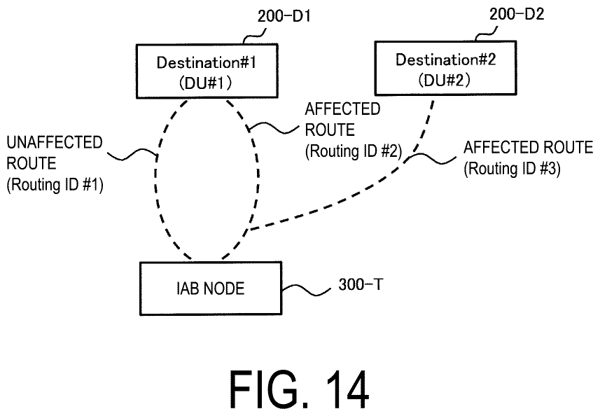

FIG. 14 is a diagram illustrating a route example according to the first embodiment. As illustrated in FIG. 14, routing ID #2 is the same Destination for unaffected routing ID #1, and thus the IAB node 300-T includes the routing ID in the additional information. On the other hand, affected routing ID #3 is a different Destination for unaffected routing ID #1, and thus the BAP address of DU #2 (200-D2) may be included in the additional information, instead of routing ID #3. When there are a plurality of routes (plurality of routing IDs) in routes from the IAB node 300-T to DU #2 (200-D2), overhead of Type-2 Indication can be reduced, using the BAP address (Destination) as the representative value. In other words, in the example of FIG. 14, the additional information includes routing ID #2 and the destination BAP address of DU #2 (200-D2). Referring back to FIG. 11, in Step S17, the IAB node 300-T generates a Type-2 Indication BAP Control PDU.

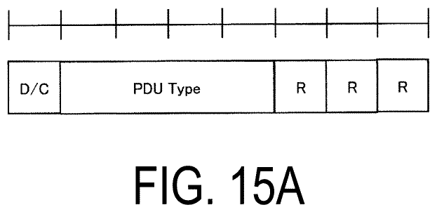

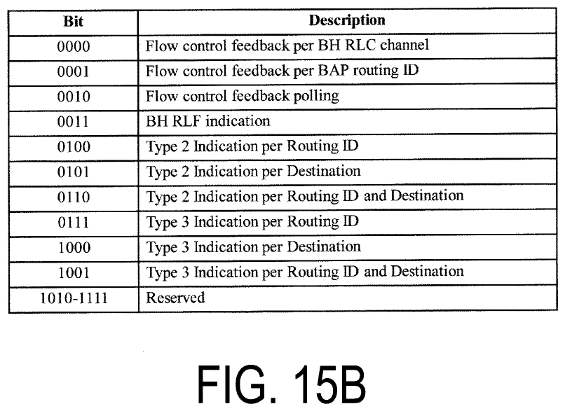

FIG. 15A is a diagram illustrating a configuration example of a header part of the Type-2 Indication BAP Control PDU according to the first embodiment.

As the additional information, information is included which indicates whether only the Destination is included (the case of Step S15), only the routing ID is included (the case of Step S16), or the Destination and the routing ID are included (the case of Step S16). The information may be referred to as identification information.

Firstly, as the additional information, when only the Destination is included, or only the routing ID is included, 1 bit of the identification information suffices. In this case, for example, the identification information may be indicated using 1 bit of a reserved area “R” in the header part illustrated in FIG. 15A. For example, in a case of “0”, it is indicated that the PDU includes the routing ID as the additional information, and in a case of “1”, it is indicated that the PDU includes the Destination as the additional information. “0” and “1” may indicate the opposite.

Secondly, as the additional information, when the Destination and the routing ID are included, the identification information is indicated using 2 bits. For example, a first bit of “0” or “1” indicates whether the routing ID is included, and a second bit of “0” or “1” indicates whether the Destination is included. The first bit and the second bit may indicate the opposite. “00” may indicate that the additional information is not included in the PDU. The identification information may be indicated using 2 bits of the reserved area “R” of the header part illustrated in FIG. 15A.

Note that, even when only the Destination is included (the case of Step S15) or only the routing ID is included (the case of Step S16), 2 bits may be used as the identification information. For example, in a case of “10”, the PDU includes only the routing ID, and in a case of “01”, the PDU includes only the Destination.

Thirdly, what type of additional information is included in the PDU may be indicated using “PDU Type” without using the reserved area of the header part. FIG. 15B is a diagram illustrating an example of PDU Type according to the first embodiment. As illustrated in FIG. 15B, as the additional information (or the identification information) of Type-2 Indication, bit examples of a case of only the routing ID, a case of only the Destination, or a case in which both of those are included are illustrated. Furthermore, as illustrated in FIG. 15B, bit examples indicating the additional information (or the identification information) of Type-3 Indication are also included.

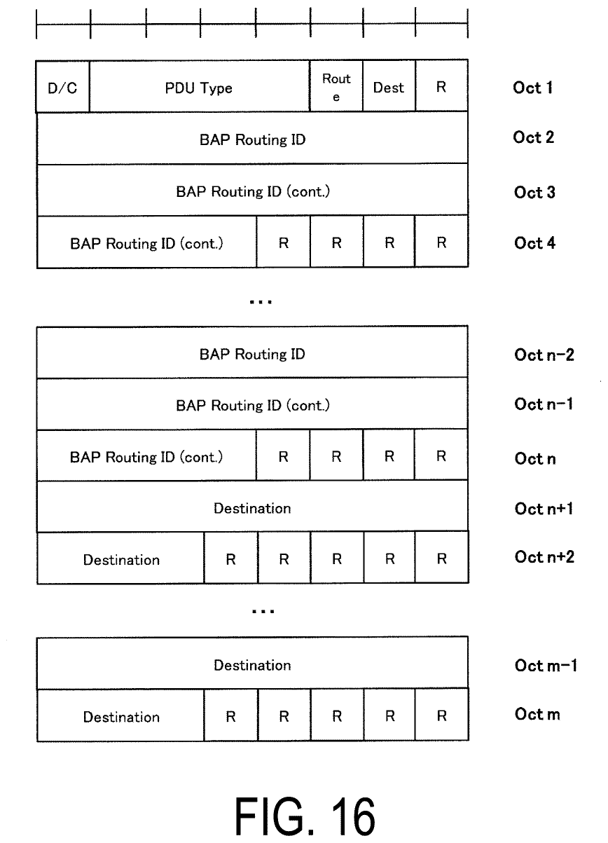

FIG. 16 is a diagram illustrating a configuration example of the Type-2 Indication BAP Control PDU according to the first embodiment. FIG. 16 illustrates an example in which the identification information has 2 bits.

As illustrated in FIG. 16, a “Route” field (for example, a first identification information field) indicates whether the PDU includes the routing ID. A “Dest” field (for example, a second identification information field) indicates whether the PDU includes the Destination. For example, when the “Route” field is “1” and the “Dest” field is “0” (in other words, when the identification information is “10”), it is indicated that only the routing ID is included as the additional information.

In the example of FIG. 16, a plurality of “BAP Routing ID” fields (for example, BAP routing ID fields) are included from October 2 to Oct n. The “BAP Routing ID” field includes the routing ID (20 bits in the example illustrated in FIG. 16) affected due to the BH RLF. When the additional information includes two affected routing IDs, the PDU includes two “BAP Routing ID” fields.

In the example of FIG. 16, a plurality of “Destination” fields (for example, destination fields) are included from Oct (n+1) to Oct m. The “Destination” field includes the destination BAP address (10 bits in the example illustrated in FIG. 16) affected due to the BH RLF. When the additional information includes three affected destination BAP addresses, the PDU includes three “Destination” fields.

Note that the Type-2 Indication BAP Control PDU may be hereinafter referred to as Type-2 Indication.

Referring back to FIG. 11, in Step S18, the IAB node 300-T transmits Type 2 Indication generated in Step S17 to the child node 300-C.

In Step S19, the child node 300-C receives the Type-2 Indication. The child node 300-C may locally reroute a packet belonging to the affected Destination and/or the affected routing ID. To locally reroute is to transfer a packet to an alternative path, for example.

Then, in Step S20, a series of processing ends.

### Second Operation Example According to First Embodiment

A second operation example according to the first embodiment will be described.

The first operation example described above has described that, in a case of “00” as the identification information, the Type-2 Indication BAP Control PDU includes neither the “BAP Routing ID” field nor the “Destination” field. The second operation example is an example in which, when the PDU includes neither the “BAP Routing ID” field nor the “Destination” field, it is interpreted that “all of the routes are affected”, instead of “all of the routes are unaffected”.

For example, as illustrated in FIG. 9, when the IAB node 300-T has single connectivity with the parent node 300-P and a BH RLF occurs in BH link #1, all of the routes become unavailable, which signifies that “all of the routes are affected”. In such a case, the IAB node 300-T includes neither the “routing ID” nor the “Destination” in Type-2 Indication as the additional information (in other words, does not include two fields in the PDU). In 3GPP, in a case of single connectivity, no inclusion of the additional information in Type-2 Indication is agreed upon, and it can be said that the above interpretation of “all of the routes are affected” accords with such an agreement.

For example, as illustrated in FIG. 10, even in a case of DC connection, when a BH RLF occurs in BH link #2 on the SCG side, the SCG side handles the user plane, and thus substantially, all of the routes may become unavailable. In other words, also when a BH RLF is detected in the BH link on the SCG side, by not including the additional information in Type-2 Indication, the above agreement is accorded with.

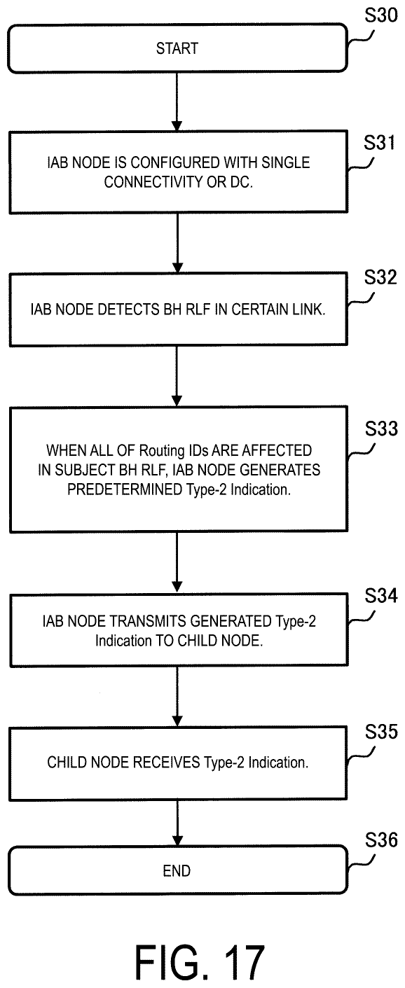

FIG. 17 is a diagram illustrating the second operation example according to the first embodiment.

As illustrated in FIG. 17, in Step S30, the IAB node 300-T starts processing.

In Step S31, the IAB node 300-T is configured with single connectivity or DC.

In Step S32, the IAB node 300-T detects a BH RLF in a certain link. For example, when the IAB node 300-T has single connectivity with the parent node 300-P, an RLF is detected in the BH link (FIG. 9) with the parent node 300-P. For example, when the IAB node 300-T has DC connection, an RLF is detected in BH link #2 (FIG. 10) with the parent node 300-P2 on the SCG side.

In Step S33, when all of the routing IDs are affected due to the BH RLF (or when all of the routing IDs are affected routing IDs), predetermined Type-2 Indication is generated.

Firstly, an example is given in which “0” is set to both of the “Route” field and the “Dest” field of the header part of the Type-2 Indication BAP Control PDU (FIG. 16). The Type-2 Indication BAP Control PDU set as described above may be the predetermined Type-2 Indication.

Secondly, an example is given in which a new bit is defined in a reserved field of the header part of the BAP Control PDU (FIG. 15A). In other words, a 1-bit Info field is provided in the reserved area. It is an example in which the Type-2 Indication BAP Control PDU including the Info field in the header part of the BAP Control PDU (FIG. 15A) is the predetermined Type-2 Indication. For example, in a case of “0”, the Info field indicates that an additional information field (the “routing ID” field and the “Destination” field) is not included, and in a case of “1”, the Info field indicates that the additional information field is included. “0” and “1” may indicate the opposite.

In Step S34, the IAB node 300-T transmits the generated predetermined Type-2 Indication to the child node 300-C.

In Step S35, the child node 300-C receives the predetermined Type-2 Indication. From the header part of the BAP Control PDU, the child node 300-C can recognize that the Type-2 Indication does not include the additional information, and can recognize that all of the routes are affected due to the BH RLF (Step S32). The child node 300-C may locally reroute a packet belonging to all of the routing IDs.

Then, in Step S36, a series of processing ends.

### Second Embodiment

A second embodiment will be described.

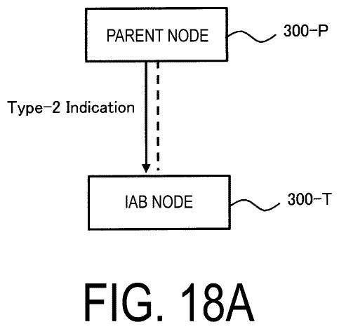

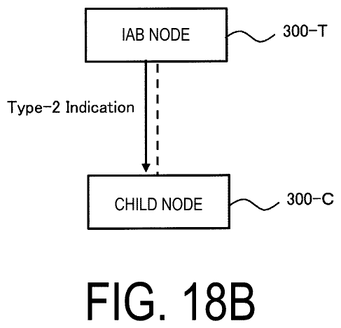

FIG. 18A is a diagram illustrating an inter-node configuration example according to the second embodiment.

As illustrated in FIG. 18A, the IAB node 300-T that has received the Type-2 Indication from the parent node 300-P may perform local rerouting, may perform a Conditional Handover (CHO), or may perform various actions, with a trigger of reception of the Type-2 Indication.

On the other hand, in 3GPP, it is agreed that, when the IAB node 300-T receives Type-3 Indication from the parent node 300-P, the action triggered by reception of Type-2 Indication is canceled. This is for the following reason: although the IAB node 300-T performs an action for the BH RLF in response to reception of Type-2 Indication, there is less need to perform the action if the BH RLF recovers.

In the IAB node 300-T, basically, all of the routes become available in response to a change of routing configuration being performed by the donor node 200. An unavailable routing ID due to an old routing configuration may be assigned to an available route due to a new routing configuration (the same routing ID may be reused).

Accordingly, in the IAB node 300-T, when the routing configuration is changed, it is preferred that the action be not continued.

In view of this, the second embodiment is an embodiment regarding canceling the action triggered by reception of Type-2 Indication also by other than Type-3 Indication. In other words, the second embodiment will describe an example in which, when the routing configuration is changed by the donor node 200, the IAB node 300-T cancels the action triggered by reception of Type-2 Indication.

Specifically, firstly, the relay node (for example, the IAB node 300-T) receives the failure occurrence notification indicating occurrence of a failure from the parent node (for example, the parent node 300-P). Secondly, the relay node performs a predetermined action in response to reception of the failure occurrence notification (for example, Type-2 Indication). Thirdly, the relay node cancels the predetermined action in response to predetermined processing being performed. Here, the predetermined processing includes the change of the routing configuration.

When the change of the routing configuration is performed, the IAB node 300-T can appropriately perform routing using the new changed routing configuration by canceling the action triggered by reception of Type-2 Indication.

### First Operation Example According to Second Embodiment

A first operation example according to the second embodiment will be described.

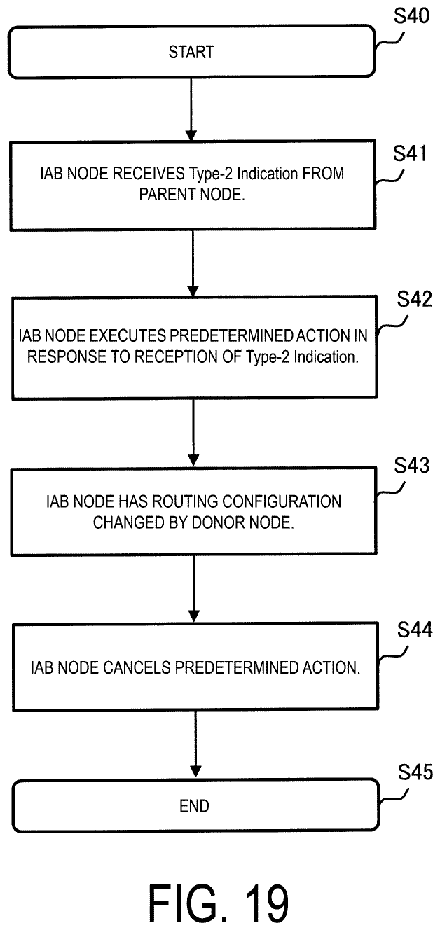

FIG. 19 is a diagram illustrating the first operation example according to the second embodiment.

As illustrated in FIG. 19, in Step S40, the IAB node 300-T starts processing.

In Step S41, the IAB node 300-T receives Type-2 Indication from the parent node 300-P.

In Step S42, the IAB node 300-T executes a predetermined action in response to reception of the Type-2 Indication.

Firstly, the predetermined action may be an action of considering that the BH link in which the Type-2 Indication is received is unavailable. For example, in FIG. 18A, when the IAB node 300-T receives the Type-2 Indication from the parent node 300-P, the IAB node 300-T considers that the BH link with the parent node 300-P is unavailable.

Secondly, the predetermined action may be an action of considering that the Routing ID(s) of which the IAB node 300-T has been notified through the additional information of the Type-2 Indication is unavailable. Alternatively, the predetermined action may be an action of considering that the Destination(s) (or the Routing ID(s) matching the Destination(s)) of which the IAB node 300-T has been notified through the additional information of the Type-2 Indication is unavailable.

Thirdly, the predetermined action may be starting of local rerouting.

Fourthly, the predetermined action may be an action of stopping or reducing transmission of at least one selected from the group consisting of a Scheduling Request (SR), a Buffer Status Report (BSR), and an uplink transmission.

Fifthly, the predetermined action may be an action of removing IAB Support being an Information Element (IE) included in a System Information Block (SIB) from the SIB. IAB support includes cell (re-) selection candidates in the IAB node 300-T.

Sixthly, the predetermined action may be triggering of the conditional handover (CHO).

In Step S43, the IAB node 300-T has the routing configuration changed by the donor node 200. The change of the routing configuration is an example of the predetermined processing performed in the IAB node 300-T.

In Step S44, when the change of the routing configuration is performed in Step S43, the IAB node 300-T cancels the predetermined action executed in Step S42. Alternatively, the IAB node 300-T cancels the predetermined action, brings it back to an original state, or brings it back to a regular state.

Firstly, the change of the routing configuration is performed in the donor node 200 for countermeasures against the BH RLF in a topology or load distribution of the topology. The change of the routing configuration may be performed when a new IAB node 300-T is provided, for example. Furthermore, the change of the routing configuration may be performed when the IAB node 300-T is removed due to a defect or the like. Furthermore, the change of the routing configuration may be performed when the IAB node 300-T is stopped due to a defect or the like. Specifically, for example, the change of the routing configuration may be performed when the BAP layer of the IAB-MT of the IAB node 300-T is notified of the change of the routing configuration by the IAB-DU of the IAB node 300-T. Then, in Step S44, when the change of the routing configuration is performed, the IAB node 300-T cancels the predetermined action executed in Step S42.

Secondly, the change of the routing configuration may be performed when a Mobile IAB node moves to another parent node in the topology or to another topology due to a handover. Alternatively, the change of the routing configuration may be performed when a Mobile IAB node enters from another parent node in the topology or from another topology due to a handover. In other words, the change of the routing configuration is performed when a handover is executed. Specifically, the time at which the IAB-MT of the IAB node 300-T receives RRC Reconfiguration with sync from a source cell may be the time at which the handover is executed. Specifically, the time at which the IAB-MT of the IAB node 300-T transmits (or completes transmitting) an RRC Reconfiguration Complete message to a target cell may be the time at which the handover is executed. Note that “the time at which transmission is completed” is the time at which a lower layer of the BAP layer of the IAB-MT receives a transmission confirmation (Ack), for example. The BAP layer may receive a notification related to the transmission confirmation from an upper layer (an RRC layer) or a lower layer (an RLC layer, a MAC layer, or a PHY layer). Then, in Step S44, when such a handover is executed, the IAB node 300-T cancels the predetermined action executed in Step S42. The execution of the handover by the IAB node 300-T is an example of the predetermined processing performed in the IAB node 300-T.

Thirdly, for example, the change of the routing configuration may be performed when the IAB node 300-T performs RRC reestablishment (RRC Reestablishment) and moves from a topology to another topology or enters from another topology to the topology. Alternatively, the change of the routing configuration may be performed when the IAB node 300-T moves to another parent node due to RRC reestablishment. In other words, the change of the routing configuration is performed when RRC reestablishment is executed. Specifically, the time at which the IAB-MT of the IAB node 300-T transmits an RRC reestablishment request (RRC Reestablishment Request) to the CU of the donor node 200 may be the time at which RRC reestablishment is executed. Specifically, the time at which the IAB-MT of the IAB node 300-T receives RRC reestablishment (RRC Reestablishment) from the CU of the donor node 200 may be the time at which RRC reestablishment is executed. Furthermore, specifically, the time at which the IAB-MT of the IAB node 300-T transmits (or completes transmitting) RRC reestablishment complete (RRC Reestablishment Complete) to the CU of the donor node 200 may be the time at which RRC reestablishment is executed. Then, in Step S44, when such RRC reestablishment is executed, the IAB node 300-T cancels the predetermined action executed in Step S42. The execution of the RRC reestablishment by the IAB node 300-T is an example of the predetermined processing performed in the IAB node 300-T.

Then, in Step S45, the IAB node 300-T ends a series of processing.

### Variation of First Operation Example

A variation of the first operation example according to the second embodiment will be described.

In the first operation example according to the second embodiment, as the predetermined processing, examples of the change of the routing configuration, the handover by the IAB node 300-T, and the execution of RRC reestablishment by the IAB node 300-T have been described. As a variation, the predetermined processing may include reception of Type-4 Indication. In other words, when the IAB node 300-T receives Type-4 Indication from the parent node 300-P, the IAB node 300-T may cancel the action executed with a trigger of reception of Type-2 Indication. This is for the following reason: the IAB node 300-T cannot expect recovery of the BH RLF because of reception of Type-4 Indication, and even if the action executed in response to reception of Type-2 Indication is continued, there is not much need for the continuation.

In the first operation example according to the second embodiment, reception of Type-2 Indication (Step S41 of FIG. 19) has been described. Instead of the Type-2 Indication, DL flow control feedback may be used. In other words, in Step S41, the IAB node 300-T receives the DL flow control feedback from the child node 300-C. In Step S42, with a trigger of reception of the DL flow control feedback, a predetermined action is executed.

Firstly, the predetermined action in this case may be an action of considering that the Routing ID(s) (or BH RLC channel(s)) (or the BH link associated with these) in which an available buffer size included in the DL flow control feedback is below a threshold has congestion or is unavailable.

Secondly, the predetermined action in this case may be starting of local rerouting.

In a manner the same as and/or similar to the first operation example, when the change of the routing configuration is performed in Step S43, in Step S44, the IAB node 300-T may cancel the predetermined action executed with a trigger of reception of the DL flow control feedback.

### Second Operation Example According to Second Embodiment

A second operation example according to the second embodiment will be described. The first operation example according to the second embodiment has described an example in which, when the IAB node 300-T receives Type-2 Indication from the parent node 300-P, the IAB node 300-T determines to cancel the action executed with a trigger of reception of the Type-2 Indication on its own. The second operation example according to the second embodiment will describe a condition that the IAB node 300-T transmits Type-3 Indication.

Specifically, firstly, the parent node (for example, the IAB node 300-T) transmits the failure occurrence notification. Secondly, the parent node transmits a failure recovery notification indicating recovery from a failure to the relay node (for example, the child node 300-C) in response to the change of the routing configuration being performed by the donor node (for example, the donor node 200).

Thus, for example, the child node 300-C that has received the Type-3 Indication from the IAB node 300-T cancels the action executed with a trigger of reception of the Type-2 Indication, in a manner the same as and/or similar to the first operation example. This is for the following reason: there is not much need for the child node 300-C to continue the predetermined action triggered by reception of the Type-2 Indication even after recovery of the failure.

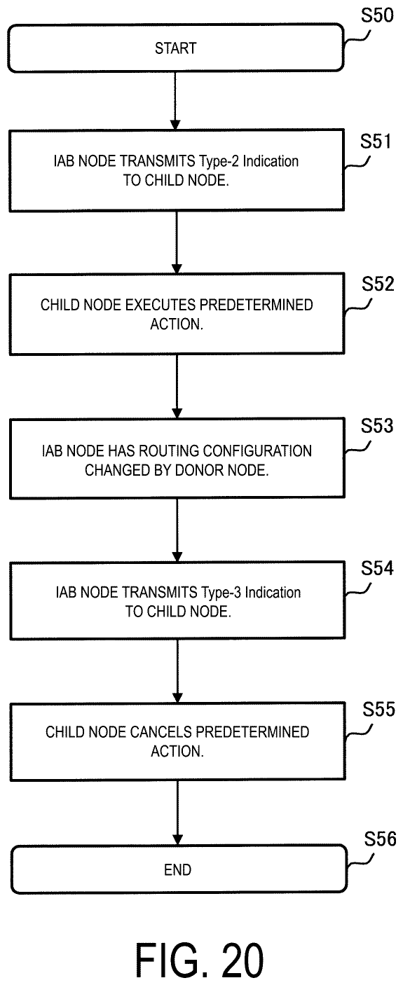

FIG. 18B is a diagram illustrating an inter-node configuration example according to the second embodiment. FIG. 20 is a diagram illustrating the second operation example according to the second embodiment. With reference to the configuration example illustrated in FIG. 18B, the second operation example illustrated in FIG. 20 will be described.

As illustrated in FIG. 20, in Step S50, the IAB node 300-T starts processing.

In Step S51, the IAB node 300-T detects a BH RLF, and transmits Type-2 Indication to the child node 300-C.

In Step S52, the child node 300-C executes a predetermined action with a trigger of reception of the Type-2 Indication. The predetermined action is the same as and/or similar to the predetermined action of the first operation example (Step S42 of FIG. 19).

In Step S53, the IAB node 300-T has the routing configuration changed by the donor node 200.

In Step S54, the IAB node 300-T transmits Type-3 Indication to the child node 300-C. In a manner the same as and/or similar to the first operation example, basically, all of the routes become available in response to the change of the routing configuration, and thus the IAB node 300-T transmits the Type-3 Indication. The IAB node 300-T may transmit the Type-3 Indication in response to reception of a routing configuration update (configuration update complete) message transmitted from the donor node 200.

In Step S55, the child node 300-C cancels the predetermined action executed in Step S52. Alternatively, the child node 300-C performs at least one selected from the group consisting of canceling the predetermined action executed in Step S52, bringing it back to an original state, and bringing it back to a regular state.

In Step S56, a series of processing ends.

### Third Embodiment

A third embodiment will be described.

The IAB node 300-T may transmit a BSR to the parent node 300-P. The BSR is used by the IAB node 300-T to provide the parent node 300-P with information related to a UL data volume in a MAC entity. The IAB node 300-T determines a UL data volume available in a logical channel in accordance with a data volume calculation procedure, and basically, triggers the BSR when UL data of the logical channel belonging to a logical channel group (LCG) becomes available in the MAC entity.

The IAB node 300-T may transmit an SR to the parent node 300-P. The SR is used when the IAB node 300-T requests the parent node 300-P for UL resources for new transmission. The IAB node 300-T may trigger the SR when the IAB node 300-T cannot transmit the BSR.

The parent node 300-P that has received the BSR or the SR assigns radio resources to the IAB node 300-T, using a UL Grant.

In 3GPP, regarding the BSR and the SR, it is agreed that, when Type-2 Indication is received, transmission thereof is stopped or reduced.

For example, when the parent node 300-P of the IAB node 300-T further has single connectivity with its upper node, the IAB node 300-T that has received Type-2 Indication from the parent node 300-P cannot perform UL transmission. Thus, in a case of single connectivity, the above agreement can be applied.

However, when the parent node 300-P further has DC connection to its upper node, it may pose a problem.

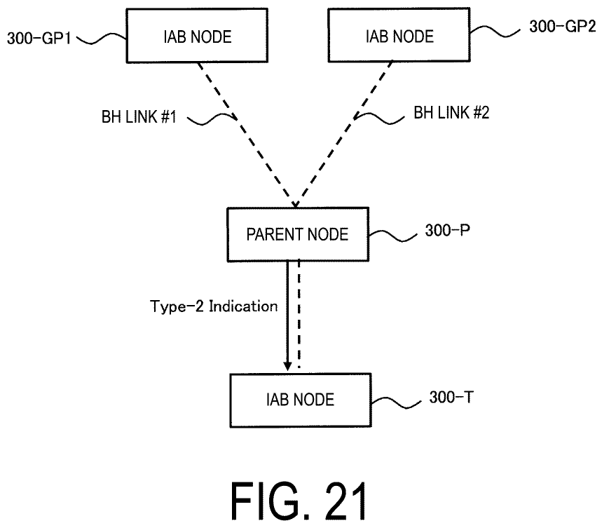

FIG. 21 is a diagram illustrating an inter-node configuration example according to the third embodiment. As illustrated in FIG. 21, the parent node 300-P has DC connection to an IAB node 300-GP1 and an IAB node 300-GP2, which are parent nodes of the parent node 300-P. The IAB node 300-GP1 is on the MCG side, and the IAB node 300-GP2 is on the SCG side.

In such a configuration, when both of the MCG side and the SCG side have BH RLFs (in other words, when both BH link #1 and BH link #2 have RLFs), in a manner the same as and/or similar to the case of single connectivity, UL transmission cannot be performed, and thus the above agreement can be applied.

However, when a BH RLF occurs on the MCG side or the SCG side (in other words, BH link #1 or BH link #2), UL transmission can be performed in one of the BH links, even if Type-2 Indication is received from the parent node 300-P. Accordingly, it can also be considered that the IAB node 300-T need not be caused to stop or reduce transmission of the SR or the BSR.

In view of this, the third embodiment will describe an example in which a logical channel corresponding to the routing ID that has become unavailable due to Type-2 Indication is identified, a data volume of data available for transmission corresponding to the logical channel is excluded from the BSR, and transmission thereof is performed.

Specifically, firstly, the relay node (for example, the IAB node 300-T) receives the failure occurrence notification (for example, Type-2 Indication) indicating occurrence of a failure from the parent node (for example, the parent node 300-P). Secondly, the relay node identifies a logical channel ID corresponding to an unavailable routing ID included in the failure occurrence notification. Thirdly, the relay node performs exclusion processing of excluding data available for transmission corresponding to the logical channel ID from a target of the BSR. Fourthly, the relay node transmits the BSR to the parent node.

In this manner, for example, the IAB node 300-T excludes data available for transmission to be transmitted to a route as a target of Type-2 Indication from the BSR and then performs transmission thereof, and can thereby reduce the data volume included in the BSR. Thus, the number of times of transmission of the BSR or the SR is reduced, and the above agreement of reducing transmission of the BSR or the SR can also be accorded with.

### Operation Example According to Third Embodiment

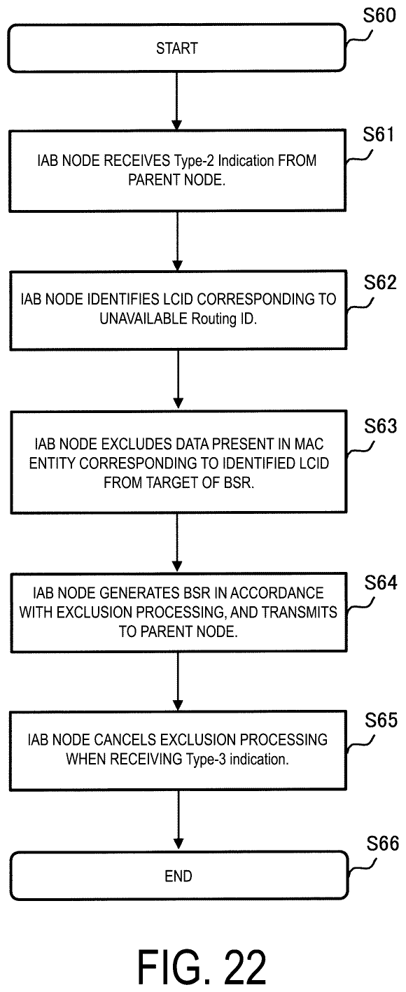

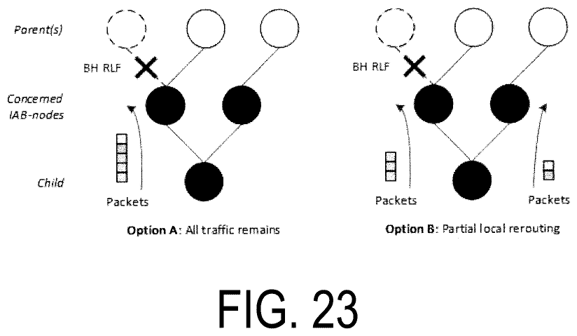

FIG. 22 is a diagram illustrating an operation example according to the third embodiment. Description will be given with reference to the configuration example illustrated in FIG. 21 as appropriate.

As illustrated in FIG. 22, in Step S60, the IAB node 300-T starts processing.

In Step S61, the IAB node 300-T receives Type-2 Indication from the parent node 300-P. The Type-2 Indication includes the unavailable routing ID as the additional information.

In Step S62, the IAB node 300-T identifies a logical channel ID (LCID) corresponding to the unavailable routing ID. The LCID can be identified as follows, for example.

In other words, the IAB node 300-T identifies the next hop address (Next BAP Address) corresponding to the unavailable routing ID from the routing configuration. Next, the IAB node 300-T identifies an egress link corresponding to the identified next hop address. Next, the IAB node 300-T identifies (all of) the BH RLC channels corresponding to the identified egress link from a BH RLC channel mapping configuration. Then, the IAB node 300-T identifies the LCID corresponding to the identified BH RLC channels from an RRC configuration.

In Step S63, the IAB node 300-T performs the exclusion processing of excluding data available for transmission present in a MAC entity and/or an RLC entity corresponding to the identified LCID from a target of the buffer size of the BSR. The data available for transmission is data available for transmission that is stored in a transmission buffer of the MAC entity (and/or the RLC entity).

The exclusion processing may be processing of excluding the data available for transmission of the LCID from the LCG. The exclusion processing may be processing of regarding the data available for transmission of the LCID as zero. Furthermore, the exclusion processing may be processing of excluding the LCG including the LCID from a BSR target. Furthermore, the exclusion processing may be processing of regarding the data available for transmission associated with the LCG including the LCID as zero.

In Step S64, the IAB node 300-T generates a BSR MAC CE in accordance with the exclusion processing, and transmits the generated BSR MAC CE to the parent node 300-P.

In Step S65, when the IAB node 300-T receives Type-3 Indication from the parent node 300-P, the IAB node 300-T cancels the exclusion processing. The cancelation of the exclusion processing may be performed at the time of the change of the routing configuration described in the second embodiment (or execution of a handover, or execution of RRC reestablishment, or reception of Type-4 Indication) other than reception of Type-3 Indication.

Then, in Step S66, the IAB node 300-T ends a series of processing.

### Other Embodiments

The embodiments, the operation examples, the processing operations, or the steps described above can be combined with each other. All of or a part of the embodiments described above can be appropriately combined as long as no inconsistencies are introduced.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### Supplementary Note 1

### Introduction

Enhancements to Integrated Access and Backhaul for NR (eIAB) is a work item that aims at enhancing topology adaptation including support for BH RLF Indication and local rerouting. In RAN2 #116e, significant progress has been made, such as details of a trigger condition of Type-2 BH RLF Indication.

In the present supplementary note, a remaining problem regarding adaptation of the Type-2/3 BH RLF is discussed, based on the latest agreement.

### Discussion

### Transmission of Type-2 Indication for Dual Connectivity

In RAN2 #116-e, the following has been agreed as the trigger condition of Type-2 BH RLF Indication.

Type-2 Indication by a dual connectivity node is triggered when the node initiates RRC reestablishment and there is no fast MCG recovery as a result of the BH RLF of both of the CGs or the BH RLF of the MCG.

As the trigger condition of Type-2 Indication by a single connectivity node, initiation of RRC reestablishment is a sufficient condition.

This agreement is well matched for both of the cases of the IAB node of single connectivity and the IAB node of dual connectivity, and it is considered that a common operation is intended regarding the Type-2 BH RLF, regardless of the case of single/dual connectivity. However, there is a problem that the agreed operation may not be applied to the case of EN-DC.

In EN-DC, the MCG link (MeNB) is only used for control plane signaling, and data is always transferred via the SCG link (SgNB). In this case, since the SCG RLF directly affects packet transferring of a child node, a related IAB node needs to transmit the Type-2 Indication to the child node even if the MCG is still in operation. However, when the MCG link is not available yet, RRC reestablishment is not initiated, and thus the SCG RLF cannot trigger the Type-2 Indication.

Observation 1: In EN-DC, the Type-2 BH RLF Indication needs to be transmitted in a case of the SCG RLF (in other words, an NR link), and this cannot allow execution of local rerouting via the MCG (in other words, an LTE link), and thus in the scenario, the BH RLF does not occur from both of the CGs (in other words, RRC reestablishment is not initiated).

The same and/or a similar scenario can also be considered in CP/UP-separated NR-DC. In other words, the MCG is used only for CP transfer, and the SCG is used for UP transfer.

Observation 2: In CP/UP-separated NR-DC, for example, when the MCG is for CP and the SCG is for UP, in a manner the same as and/or similar to the case of EN-DC of Observation 1, the Type-2 BH RLF Indication needs to be transmitted in a case of the SCG RLF (in other words, a UP link), even when the MCG is satisfactory.

Further study is required regarding the following operation for covering the above scenario. In other words, the Type-2 BH RLF Indication is transmitted only with the SCG RLF (the BH RLF is not transmitted in the MCG).

When a node detects the BH RLF in any of the BHs and rerouting of affected traffic cannot be executed, whether the Type-2 Indication by the dual connectivity node is triggered requires further study (if agreed, see R2-211539 for details).

It goes without saying that the operation can cover the basic scenario agreed in RAN2, in other words, transmission of the Type-2 BH RLF Indication when both of the links (in other words, the MCG and the SCG) experience the BH RLF (or RRC reestablishment is initiated), in which case all the routes cannot be locally rerouted. The operation can cover each of the cases of EN-DC and NR-DC with CP/UP separation in Observation 1 and Observation 2.

Observation 3: “The Type-2 Indication by the dual connectivity node can be triggered when the node detects the BH RLF in any of the BHs and rerouting of affected traffic cannot be executed”, which is a solution that requires further study, can be applied to all of the scenarios.

In consideration of the above observations, when at least one route is unavailable due to the BH RLF, it can be considered that transmission of the Type-2 Indication is a simple solution. In particular, one solution can address both of the cases of single connectivity and dual connectivity, and both of NR-DC and EN-DC. For example, in a case of single connectivity, the BH RLF causes all of the paths to be unavailable. In EN-DC, the MCG RLF does not affect any path, and the SCG RLF causes all of the paths to be unavailable. In NR-DC, the BH RLF may or may not affect some of the paths, depending on mapping between the BH links and the paths. Thus, RAN2 needs to agree on the unified operation regarding the trigger condition of the Type-2 Indication.

Proposal 1: RAN2 needs to agree on transmission of the Type-2 BH RLF Indication when at least one route is unavailable at the time of the BH RLF, in other words, when local rerouting cannot be executed, regardless of whether the IAB node is for single connectivity or dual connectivity, and regardless of EN-DC or NR-DC.

### Partial Local Rerouting when Receiving Type-2 Indication

It is worth considering how the child node having dual connectivity operates when receiving the Type-2 Indication. When the parent node (the IAB node) detects the BH RLF but can still execute local rerouting, the child node having dual connectivity has the following pair of operation options.
Option A: Cause all the upstream traffic to remain in the parent node, in other words, not cause the child node to perform local rerouting.
Option B: Cause another parent node to reroute a part of the upstream traffic, in other words, perform “partial” local rerouting.

Option A is a simple operation; however, the parent node loses one of the links (in other words, the MCG or the SCG) due to the BH RLF, and thus overload may occur in the parent node. On the other hand, Option B can distribute the load to two parent nodes of the child node, although the Type-2 Indication needs to carry the additional information. Therefore, it is expected that Option B further enhances performance of the entire topology.

Observation 4: When receiving the Type-2 BH RLF Indication, the child node can have an option as to whether to execute the “partial” local rerouting for better load distribution (i.e., Option B).

Proposal 2: RAN2 needs to discuss whether to execute the “partial” local rerouting in the child node (i.e., Option B) when the parent node in dual connectivity experiences the BH RLF.

When the partial rerouting (i.e., Option B) is a desirable operation as in Proposal 2, the child node needs to know which path is unavailable, because the child node needs to determine which traffic is to stay in the original path and which traffic is to be used as a target of the partial rerouting. It is easily known that the Type-2 Indication includes an unavailable routing ID due to the BH RLF.

Proposal 3: RAN2 needs to agree that the Type-2 BH RLF Indication indicates a routing ID that is unavailable due to the BH RLF.

Proposal 4: RAN2 needs to agree that when the routing ID is indicated in the received Type-2 BH RLF Indication, the child node considers the routing ID to be unavailable.

### Type-3 Indication for Single Connectivity and Dual Connectivity

In RAN2 #116e, the following has been agreed regarding when to transmit Type-3BH RLF Indication. This is in line with the current agreement of RAN2 that the Type-2BH RLF Indication is transmitted when both of the links have the BH RLF.

When the node succeeds in reestablishment, the node can transmit the Type-3 Indication. How to define detailed conditions for reestablishment success, such as RRC reestablishment complete transmission success, will be further studied. Further study will be required as to whether to include an additional trigger condition such as Reconfiguration Complete transmission success for when the node initiates reestablishment, selects a CHO candidate cell, and succeeds in the CHO.

The node can transmit the Type-3 Indication only if the node has previously transmitted the Type-2 Indication. In other words, the Type-3 Indication cannot be triggered without having previously triggered the Type-2 Indication.

However, if Proposal 1 can be agreed, it can be considered reasonable that the Type-3 Indication is transmitted only when at least one path succeeds in BH RLF recovery and becomes available again, in other words, the state changes from “unavailable” to “available”. This operation can be applied to the cases of single connectivity and dual connectivity including NR-DC and EN-DC, in a manner the same as and/or similar to Proposal 1.

Proposal 5: RAN2 needs to agree that the Type-3 BH RLF Indication is transmitted when recovery of the BH RLF succeeds and at least one route becomes available again.

When Proposal 3 can be agreed, the child node also needs to be notified of the Routing ID that has become available again. The child node considers these routing IDs to be routable and stops the local rerouting of the relevant traffic.

Proposal 6: RAN2 needs to agree that the Type-e BH RLF Indication indicates the routing ID that has become available again due to successful BH RLF recovery.

Proposal 7: RAN2 needs to agree that when the routing ID is indicated in the received Type-3 BH RLF Indication, the child node considers the routing ID to be available.

### Other Possible Conditions for Canceling Action

RAN2 #116e has agreed that the action triggered when the Type-2 Indication was previously received is brought back to the original action when the Type-3 Indication is received as follows.

When Type-2F Indication is received, the node needs to perform local rerouting, if possible.

When Type-3F Indication is received, the operation (for example, the local rerouting) that was triggered when the Type-2F Indication was previously received needs to be reversed, if possible.

Based on these agreements, for the IAB node to bring the action triggered due to the previous Type-2 Indication back to the original action, whether there are other conditions can be studied. For example, the following cases and the like can be considered in which the routing configuration of the IAB node is updated by the donor for load balancing, handover, RRC reestablishment, or the like. A new configuration, such as one in which the parent node is no longer the parent node of the child node, causes the parent node to be unable to transmit the Type-3 Indication and the child node to be unable to receive the Type-3 Indication.

Proposal 8: RAN2 needs to discuss whether there is a condition, other than the Type-3 BH RLF Indication, for the IAB node to bring the action triggered due to the previous Type-2 BH RLF Indication back to the original action, for example, a case in which the routing configuration is updated or the like.

### Transmission of Type-2 Indication

RAN2 #116e has agreed on the following items that require further study.

When the received Type-2 Indication needs to be further transmitted, which option is to be taken by the items that require further study.
Option 1) The received Type-2 Indication is not to be transmitted any more (unless a regular Type-2 trigger condition is satisfied).
Option 2) When the Type-2 Indication is received, the node needs to further transmit the Type-2 Indication to the child node if there is no available alternative path.

Transmission of the Type-2 Indication aims to provide better topology management, such as load distribution and reduced service interruption.

Specifically, various proposals have been made. One of the proposals is that the IAB node receives the Type-2 Indication and transfers the Type-2 Indication when there is no alternate path. This is chiefly consistent with the operation of the IAB node based on Option 1 of Proposal 1. In other words, this condition can be interpreted as a condition that the IAB node does not perform the local rerouting, including the partial local rerouting of Proposal 2. Another option is to limit the transmission of the Type-2 Indication to only one hop, which is expected for stable topology management. Obviously, the case of dual connectivity, in other words, Proposal 1, is still dependent upon how the Type-2 Indication is transmitted or whether the “partial” local rerouting in the child node is considered, in other words, Proposal 2. Therefore, at present, details thereof need to remain as the items that require further study.

Proposal 9: RAN2 needs to agree that the transmission of the Type-2 Indication to the child node is supported. Detailed conditions, such as transferring only when the IAB node does not perform the local rerouting, are further studied.

### Disabling or Reducing SR/BSR by Type-2 Indication

While RAN2 #113e agrees that “the Type-2 RLF Indication can be used as a trigger for deactivation or reduction of SR and/or BSR transmission”, RAN2 #116e agrees the following.

RAN2 does not define UL transmission restriction (SR/BSR and the like) for the node that has received the Type-2 Indication. In other words, whether the node can transmit in the uplink is up to implementation of the node, and is also up to a scheduling policy of the node that transmits the Type-2 Indication. Whether Note needs to be added to CR of Stage 2/3 requires further study.

It is considered as the operation of the IAB-MT, and it is thus considered necessary to be defined clearly. Otherwise, for example, implementation is unclear as to whether the IAB-MT is allowed to avoid UL transmission or the like even when a condition defined for UL transmission is satisfied. However, the above agreement has already been achieved, and thus the item that requires further study is only whether to add Note to specifications. It is considered that Note is effective in order to forestall unnecessary misunderstanding of specification conformity in implementation of the IAB-MT; for example, although implementation is performed as intended by RAN2, another person makes a complaint that it is not described in the specification. Thus, Note is added to Stage-2 and Stage-3 specifications.

Proposal 10: RAN2 needs to agree to add, to the Stage-2/3 specifications, that when the Type-2 BH RLF Indication is received, the IAB-MT stops or reduces transmission of the SR or the BSR.

### Switching of IAB Support in SIB by Type-2 Indication

In RAN2 #116e, the following has been agreed.

RAN2 does not define that an IAB support indicator is toggled by reception of the Type-2 Indication, in other words, when the IAB support indicator is configured is up to implementation. Whether a note needs to be added to CR of Stage 2/3 requires further study.

Unlike the case of the SR/BSR, it is considered as the operation of the IAB-DU, and thus it is up to implementation of the IAB-DU from the beginning. In this sense, it is considered that there is no need to add Note for the operation.

Observation 5: Handling of an IAB support IE is up to implementation of the IAB-DU, in a manner the same as and/or similar to Rel-16.

### Supplementary Note 2

Features relating to the embodiments described above will be described.
(1)
A communication control method used in a cellular communication system, the communication control method including:
by a relay node, including additional information in a failure occurrence notification indicating occurrence of a failure in a first backhaul link between a first parent node and the relay, and transmitting the additional information to a child node; and
receiving, by the child node, the failure occurrence notification including the additional information, wherein
the additional information includes a first BAP routing ID unavailable due to the failure and/or a first destination BAP address included in the first BAP routing ID, and includes identification information indicating that the additional information includes the BAP routing ID and/or the first destination BAP address.
(2)
The communication control method according to (1), wherein
the additional information includes the first destination BAP address and does not include the first BAP routing ID, when a second destination BAP address included in a second BAP routing ID available even during the failure and the first destination BAP address are not the same BAP address.
(3)
The communication control method according to (1), wherein
the additional information includes the BAP routing ID and does not include the first destination BAP address, when a second destination BAP address available even during the failure and the first destination BAP address are the same BAP address.
(4)
The communication control method according to (3), wherein
the additional information includes the first BAP routing ID and the first destination BAP address, when a third destination BAP address included in a third BAP routing ID available even during the failure and the first destination BAP address are not the same BAP address.
(5)
The communication control method according to any one of (2) to (4), wherein
the second destination BAP address is included in the second BAP routing ID whose route includes a second backhaul link between a second parent node and the relay node without occurrence of the failure, and the third destination BAP address is included in a third BAP routing ID whose route includes the second backhaul link.
(6)
The communication control method according to (1), wherein
the transmitting includes transmitting, by the relay node, the failure occurrence notification using a BAP Control PDU, and
the identification information is indicated by a PDU Type of a header part of the BAP Control PDU.
(7)
The communication control method according to (1), wherein
the transmitting includes transmitting, by the relay node, the failure occurrence notification using a BAP Control PDU, and
the BAP Control PDU includes:
a first identification information field indicating whether the BAP Control PDU includes the first BAP routing ID;
a second identification information field indicating whether the BAP Control PDU includes the first destination BAP address;
a BAP routing ID field including the first BAP routing ID; and
a destination field including the first destination BAP address.
(8)
The communication control method according to (1), wherein
the failure occurrence notification not including the first BAP routing ID and the first destination BAP address indicates, as the additional information, that all of routes are unavailable.
(9)
A communication control method used in a cellular communication system, the communication control method including:
receiving, by a relay node, a failure occurrence notification indicating occurrence of a failure from a parent node;
performing, by the relay node, a predetermined action in response to reception of the failure occurrence notification; and
canceling, by the relay node, the predetermined action when predetermined processing is performed,
wherein the predetermined processing includes a change of a routing configuration.
(10)
The communication control method according to (9), wherein
the predetermined processing includes at least one selected from the group consisting of execution of a handover by the relay node, execution of RRC Reestablishment by the relay node, and reception of a recovery failure notification of a backhaul link by the relay node from the parent node.
(11)
The communication control method according to (9), further including:
transmitting, by the parent node, the failure occurrence notification; and
transmitting, by the parent node, a failure recovery notification indicating recovery from the failure to the relay node in response to the change of the routing configuration being performed by a donor node.
(12)
A communication control method used in a cellular communication system, the communication control method including:
receiving, by a relay node, a failure occurrence notification indicating occurrence of a failure from a parent node;
identifying, by the relay node, a logical channel ID corresponding to an unavailable routing ID included in the failure occurrence notification;
performing, by the relay node, exclusion processing of excluding data available for transmission corresponding to the logical channel ID from a target of a BSR; and
transmitting, by the relay node, the BSR to the parent node.
(13)
The communication control method according to (12), further including
canceling, by the relay node, the exclusion processing when receiving a failure recovery notification indicating recovery from the failure from the parent node.

1. A communication control method executed in a relay node, the communication control method comprising the steps of:
transmitting a failure detection notification to a child node, in response to detecting a radio link failure at all links providing an F1-U protocol on a BAP (Backhaul Adaptation Protocol) and determining that local rerouting cannot be executed.

2. A cellular communication system comprising:
a relay node; and
a child node of the relay node, wherein
the relay node configures to transmit a failure detection notification to the child node, in response to detecting a radio link failure at all links providing an F1-U protocol on a BAP (Backhaul Adaptation Protocol) and determining that local rerouting cannot be executed.

3. A relay node transceiver circuitry and processing circuitry operatively associated with the transceiver circuitry and configured to execute processing of:
transmitting a failure detection notification to a child node, in response to detecting a radio link failure at all links providing an F1-U protocol on a BAP (Backhaul Adaptation Protocol) and determining that local rerouting cannot be executed.

4. A non-transitory computer-readable storage medium storing a program for causing a computer to execute processing comprising:
transmitting a failure detection notification to a child node, in response to detecting a radio link failure at all links providing an F1-U protocol on a BAP (Backhaul Adaptation Protocol) and determining that local rerouting cannot be executed.

5. A chipset for a relay node in a cellular communication system, the chipset comprising:
transmitting a failure detection notification to a child node, in response to detecting a radio link failure at all links providing an F1-U protocol on a BAP (Backhaul Adaptation Protocol) and determining that local rerouting cannot be executed.
